(19) United States
(12) Patent Application Publication
(10) Pub. No.: US 2005/0183550 A1
(43) Pub. Date: Aug. 25, 2005

(54) Wrench extension tool

(76) Inventor: Ron Day, Mexia, TX (US)

Correspondence Address: DAVID G. HENRY;900 Washington Avenue, P.O. Box 1470, Waco, TX, 76703-1470, US

(21) Appl. No.: 10/786,558

(22) Filed: Feb. 24, 2004

(51) Int. Cl. B25B 23/16

(52) U.S. Cl. 81/177.2

(57) ABSTRACT

A wrench extension device which includes an elongate handle with oppositely directly cusps positioned near one end for engaging the medial portion of a hand wrench and extending its effective length for achieving greater torque on any nut, bolt, etc. with which the wrench is engaged.

### FIELD OF INVENTION

Applicant s invention relates to hand tools and devices for increasing torque applicable by such tools.

### BACKGROUND INFORMATION

It is common in any type of construction, farming, home improvement, or similar type project to come across a bolt that must be removed. In the process of trying to unscrew a bolt, it is typical to encounter many problems including, corrosion of materials, mineral deposits on the bolt, contraction of materials around the bolt, a bolt that someone stronger or using an impact wrench had tightened, a bolt in an inconvenient location, or other objects have been built or placed around the bolt. All these problems make the bolt extremely hard to loosen, if it can even be turned at all, and a significant amount of force must be exerted. In many if not most cases, a person does not have the physical ability to apply the required amount of force.

Different projects, such as the attachment of separate materials or the creation of fluid containment, require the addition of new bolts. If a single bolt is not tightened enough when attaching separate pieces together, movement may occur between the pieces, weakening the entire structure and possibly causing collapse and/or injury. In the case of fluid containment, if the bolts are not significantly tight the fluids will escape containment. Depending on the size of containment and the type of fluid, the fluid may flood the area, erode the equipment outside of containment, cause a hazardous environmental release, or significant injury to a person. In order to tighten the bolt to avoid these and other possible catastrophes requires an extensive amount of force, which in many cases a person is not physical able to apply.

These and other problems associated with removal of an existing bolt or the tightening of a bolt to the necessary point will delay the project until either a different instrument is located or bought, suitable mechanized equipment is obtained, or a stronger person is found or hired. This can be a time consuming, frustrating, and expensive process especially for the lone worker who is miles away from another person or store, a person of lesser strength who must hire someone, or a person who is on a tight budget.

It is common knowledge in the area of physics that increasing the length of the levering arm will increase the amount of torque on an object without having to increase the amount of force applied. Put in the common terms of a wrench and a bolt, the longer the handle of the wrench, the easier it will be for the user of the wrench to tighten or loosen the bolt applying the same amount of force.

Currently there are several ways to increase the effective length of a wrench handle, including the use of metal pipes and specialized wrenches. The problem in using pipes to increase the length of the wrench handle is that pipes, being cylindrical, do not snugly fit onto the wrench handle, causing the pipe to slip around and perhaps even slip off the wrench handle. This may cause serious injury to the user. In addition, the use of a pipe isolates the force applied to the wrench handle to one particular spot on the wrench handle, which increases the likelihood of the wrench breaking, causing greater delay and increasing the cost of the project.

The specialized wrenches designed with a longer handles often only fit particular large sized bolts and are expensive, so that the typical user either could not or would not buy one for use in one specific project. Even if the user did buy the wrench, it would be doubtful that it would be an aid in other future projects, and the process of finding another wrench would have to be repeated.

In view of the foregoing, it would serve anyone involved in construction, farming, home improvement, or similar activity to provide an inexpensive and efficient means to extend the handles of a wide range of wrenches.

### SUMMARY OF INVENTION

It is an object of the present invention to provide increased leverage to a wrench to increase torque on the object aiding in the ability for the user to turn a bolt.

In satisfaction of these and related objectives, Applicant's present invention provides a wrench extension that allows for users to turn an otherwise stationary bolt, applying the same amount of force to the extension as on the wrench.

### BRIEF DESCRIPTION OF THE DRAWINGS

FIG. 1 is an elevational front view of the Applicant s wrench extension.

FIG. 2 is a cross-sectional view of the Applicant s wrench extension s wrench holder and faceplate.

FIG. 3 is a three-dimensional view of the front of the applications wrench extension faceplate and wrench holders.

### DETAILED DESCRIPTION OF THE PREFERRED EMBODIMENT

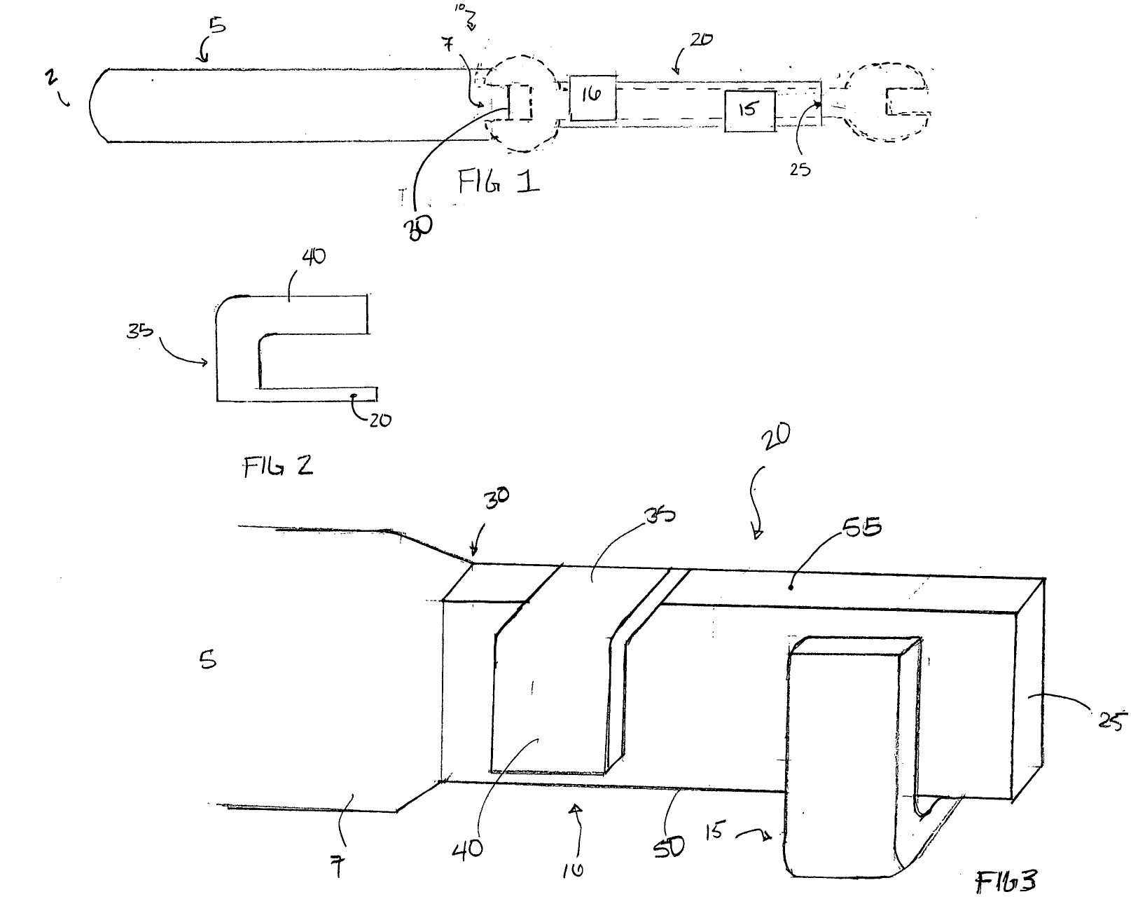

Referring to FIG. 1, the apparatus of Applicant's invention is identified by the reference numeral 10, shown encompassing a typical wrench as detailed by dashed lines. The wrench extension 10 includes handle 5 and faceplate 20. The preferred embodiment of wrench extension 10 is made completely of metal. The strength of metal allows for a significant amount of force to be applied on the wrench extension without fear of breaking each individual piece of the apparatus. A metal apparatus also allows the individual pieces to be welded together, increasing the strength of the entire apparatus and decreasing the chance of the apparatus breaking under a significant amount of force.

Handle 5 has a front end 7 and rear end 2. Handle 5 is attached to faceplate 20 at front end 7. The preferred embodiment of handle 5 is cylindrical and is at a length that is significantly longer than that of a typical wrench; therefore, wrench extension 10 effectively increases the length of the wrench handle.

The preferred embodiment of faceplate 20 is rectangular, connecting to the handle at the handle end 30 on its longitudinal axis, the opposing end of faceplate is faceplate terminal 25. Faceplate 20 is attached to first wrench holder 15 and second wrench holder 17. First wrench holder 15 is attached to faceplate 20 closer to faceplate terminal 25. The distance from the terminal of faceplate 25 should be such to allow the wrench extension to stop at a point that is close to the head of the wrench.

Second wrench holder 16 is attached to faceplate 20 at a distance closer to handle end 30. The preferred embodiment of wrench extension 10 has first wrench holder 15 and second wrench holder 16 set at a distance from each other to allow the apparatus to connect with the wrench handle at two optimum points, one point being closer to the head of the wrench and one point being closer to the end of the wrench. This allows for the force on a wrench handle to be distributed substantially equally.

Referring to FIG. 2, first wrench holder 15 has spine 35 and cusp 40 and is substantially L shaped. Cusp 40 extends over the faceplate front 22. Second wrench holder 16 is substantially similar to first wrench holder 16.

Referring to FIG. 3, first wrench holder 15 is attached to the faceplate bottom 50 along the longitudinal axis. Second wrench holder 16 is attached to the opposing side or faceplate top 55 along the longitudinal axis. (Note that the top, bottom, front and back are included for descriptive purposes only and do not relate to the specific orientation of the apparatus.) The preferred embodiment of spine 35 is that the depth of spine 35 is greater than the width of a wrench handle. The preferred embodiment of cusp 40 is a length that allows for maximum coverage of the wrench handle. The preferred embodiment of spine 25 and cusp 40 allows wrench extension 10 to slide onto the handle of a wrench, while first wrench holder 15 and second wrench holder 16 maintain a reasonably tight fit around the wrench handle, avoiding excess of movement of the wrench handle.

1. A wrench extension comprising:
an elongate, substantially cylindrical handle having a front and rear end;
an elongate substantially planar faceplate member, said faceplate member having longitudinal axis and transverse axis; terminal end and handle end; top and bottom; and front and back. Said handle end is attached to said front end of said cylindrical handle; and
means for attaching wrench handle to said substantially planar faceplate member.

2. The apparatus of claim 1, wherein
said attachment means comprise first and second attachment members, said first and second attachment members each comprising a spine and cusp, said spine being substantially perpendicular to said faceplate; said spine extends outward from said faceplate; said first attachment member is affixed said top of said faceplate along the longitudinal axis. Said cusp is substantially perpendicular and attached to said spine; said cusp extends outwardly from said spine; said cusp is on a substantially parallel plane to said faceplate. Said attachment member is located on said faceplate at a distance from said terminal end; and
said second attachment member comprising of a second spine and second cusp, said second spine is substantially perpendicular to said faceplate; said second spine extends outwardly from said faceplate; said second attachment member is affixed to said bottom of said faceplate along the longitudinal axis. Said second cusp is substantially perpendicular and attached to said second spine, said second cusp extends outwardly from said spine; said cusp is on a substantially parallel plane to said faceplate. Said attachment member is located on said faceplate at a distance from said handle end.

3. The apparatus of claim 2 comprising a plurality of said first and second attachment members.

4. The apparatus of claim 2 wherein the first and second attachment means are replaced by a solid metal cusp that attaches to the top and bottom of said faceplate for the majority of the length of said faceplate.
